(19) United States
(12) Patent Application Publication
(10) Pub. No.: US 2026/0238770 A1
(43) Pub. Date: Aug. 13, 2026

(54) DEVICE AND METHOD FOR DECODING VIDEO DATA

(71) Applicant: SHARP KABUSHIKI KAISHA, Sakai City, Osaka (JP)

(72) Inventors: CHIH-YUAN CHEN, Taipei (TW); YU-CHIAO YANG, Taipei (TW)

(21) Appl. No.: 19/471,063

(22) PCT Filed: Mar. 29, 2024
(86) PCT No.: PCT/CN2024/084685

§ 371 Date: Sep. 30, 2025

Related U.S. Application Data
(60) Provisional application No. 63/456,442, filed on Mar. 31, 2023.

(51) Int. Cl. H04N 19/11; H04N 19/119; H04N 19/136; H04N 19/172; H04N 19/176; H04N 19/593

(52) U.S. Cl. CPC H04N 19/11; H04N 19/119; H04N 19/136; H04N 19/172; H04N 19/176; H04N 19/593

(57) ABSTRACT

A method of decoding video data performed by an electronic device is provided. The method receives the video data and determines a block unit from a current frame included in the video data. The method further determines a split line of the block unit and divide the block unit based on the split line to generate geometric partitions. The method then determines, for the block unit, an intra candidate list including more than one of intra template matching prediction (IntraTMP) mode candidates, and intra block copy (IBC) mode candidates and select predicting modes from the intra candidate list. A first one of the predicting modes is a first one of the IntraTMP mode candidates. The method reconstructs the block unit based on the predicting modes. Each of the geometric partitions in the block unit is reconstructed using at least one of the predicting modes.

### CROSS-REFERENCE TO RELATED APPLICATION(S)

The present disclosure claims the benefit of and priority to U.S. Provisional Patent Application Ser. No. 63/456,442, filed on Mar. 31, 2023, entitled “Prediction Based on Multiple Intra Coding Tools,” the content of which is hereby incorporated herein fully by reference in its entirety for all purposes.

### FIELD

The present disclosure generally relates to video coding, and more specifically, to techniques for predicting a block unit based on multiple prediction modes.

### BACKGROUND

Intra template matching is a coding tool for video coding, in which, an encoder and/or a decoder may search a matching block for the current block from the reconstructed area of the current frame.

When the encoder and/or the decoder search the matching block, they merely consider multiple reference blocks, each including multiple previously reconstructed pixels. However, the previously reconstructed pixels may be inadequate to predict all of the block units in the video.

Thus, a combination of different kinds of intra mode may be required for the encoder and/or the decoder to be able to precisely and efficiently predict and/or reconstruct the block unit.

### SUMMARY

The present disclosure is directed to a device and method for predicting a block unit based on different prediction modes.

In a first aspect of the present disclosure, a method of decoding video data and an electronic device for performing the method are provided. The method includes receiving the video data; determining a block unit from a current frame included in the video data; determining a split line of the block unit based on a partition angle and a partition offset determined from the video data; dividing the block unit based on the split line to generate multiple geometric partitions; determining, for the block unit, an intra candidate list including more than one of multiple intra template matching prediction (IntraTMP) mode candidates, and multiple intra block copy (IBC) mode candidates; selecting multiple predicting modes from the intra candidate list, wherein a first one of the multiple predicting modes is a first one of the multiple IntraTMP mode candidates; and reconstructing the geometric partitions of the block unit based on the multiple predicting modes, wherein each of the multiple geometric partitions in the block unit is reconstructed using at least one of the multiple predicting modes.

In an implementation of the first aspect of the present disclosure, a first one of the multiple geometric partitions is predicted using the first one of the multiple predicting modes, a second one of the multiple geometric partitions is predicted using a second one of the multiple predicting modes selected from the multiple IntraTMP mode candidates and the multiple IBC mode candidates, and a third one of the multiple geometric partitions is predicted using the first one and the second one of the multiple predicting modes when the number of the multiple geometric partitions is equal to three.

In an implementation of the first aspect of the present disclosure, when the second one of the multiple predicting modes is a second one of the multiple IntraTMP mode candidates, the third one of the multiple geometric partitions is predicted using the first one and the second one of the multiple IntraTMP mode candidates.

In an implementation of the first aspect of the present disclosure, when the second one of the multiple predicting modes is one of the multiple IBC mode candidates, the third one of the multiple geometric partitions is predicted using the first one of the multiple IntraTMP mode candidates and the one of the multiple IBC mode candidates.

In an implementation of the first aspect of the present disclosure, the first one of the multiple geometric partitions is located at a first side of the split line, and the first side of the split line is determined based on a syntax flag included in the video data.

In an implementation of the first aspect of the present disclosure, a partition size of the third one of the multiple geometric partitions is determined based on at least one blending width of the block unit, and the third one of the multiple geometric partitions is predicted further based on the at least one blending width.

In an implementation of the first aspect of the present disclosure, the third one of the multiple geometric partitions is predicted by: generating a first predicted sub-partition for the third one of the multiple geometric partitions based on the first one of the multiple predicting modes; generating a second predicted sub-partition for the third one of the multiple geometric partitions based on the second one of the multiple predicting modes; and weightedly combining the first predicted sub-partition and the second predicted sub-partition based on the at least one blending width.

In an implementation of the first aspect of the present disclosure, the multiple intra block copy (IBC) mode candidates is selected from multiple regular IBC merge mode candidates, multiple IBC-merge mode with block vector differences (IBC-MBVD) mode candidates, multiple IBC-template matching (IBC-TM) mode candidates, and multiple IBC-advanced motion vector prediction (IBC-AMVP) mode candidates.

In an implementation of the first aspect of the present disclosure, a second one of the multiple predicting modes is selected from the multiple IntraTMP mode candidates and the multiple IBC mode candidates, and the second one of the multiple predicting modes is different from the first one of the multiple predicting modes.

In a second aspect of the present disclosure, a method of decoding video data and an electronic device for performing the method are provided. The method includes receiving the video data; determining a block unit from a current frame included in the video data; determining an intra candidate list for the block unit, wherein: the intra candidate list includes more than one of multiple intra template matching prediction (IntraTMP) mode candidates, multiple intra block copy (IBC) mode candidates, or multiple decoder-side intra mode derivation (DIMD) mode candidates, the multiple IntraTMP mode candidates is generated using an IntraTMP prediction mode, the multiple IBC mode candidates is generated using an IBC prediction mode, and the multiple DIMD mode candidates is generated using a DIMD prediction mode; selecting multiple predicting modes from the intra candidate list, wherein a first one and a second one of the multiple predicting modes are generated using two different ones of the IntraTMP prediction mode, the IBC prediction mode, and the DIMD prediction mode; and reconstructing the block unit based on the multiple predicting modes.

In an implementation of the second aspect of the present disclosure, the second one of the multiple predicting modes is generated using one of the IBC prediction mode and the DIMD prediction mode when the first one of the multiple predicting modes is generated using the IntraTMP prediction mode, the second one of the multiple predicting modes is generated using one of the DIMD prediction mode and the IntraTMP prediction mode when the first one of the multiple predicting modes is generated using the IBC prediction mode, and the second one of the multiple predicting modes is generated using one of the IntraTMP prediction mode and the IBC prediction mode when the first one of the multiple predicting modes is generated using the DIMD prediction mode.

An implementation of the second aspect of the present disclosure further includes predicting the block unit using each of the multiple predicting modes to respectively generate one of multiple predicted blocks, wherein each of the multiple predicted blocks is generated based on a corresponding one of the multiple predicting modes; determining multiple weighting factors for the multiple predicted blocks; and weightedly combining the multiple predicted blocks based on the multiple weighting factors to generate a prediction block of the block unit, wherein reconstructing the block unit is further based on the prediction block of the block unit.

In an implementation of the second aspect of the present disclosure, multiple neighboring blocks neighbors the block unit, each of the multiple neighboring blocks is predicted based on one of multiple neighboring modes, and the multiple weighting factors is determined based on whether the multiple neighboring modes is generated using the IntraTMP prediction mode, the IBC prediction mode, and the DIMD prediction mode.

An implementation of the second aspect of the present disclosure further includes determining that a portion of the multiple predicting modes is generated using a specific one of the IntraTMP prediction mode, the IBC prediction mode, and the DIMD prediction mode; determining a number L of the portion of the multiple predicting modes, wherein the number L is an integer equal to or greater than zero; and determining a portion of the multiple weighting factors for the portion of the multiple predicting modes based on the number L.

In an implementation of the second aspect of the present disclosure, each of the multiple weighting factors is derived by using one of a gaussian elimination method and an LDL decomposition.

An implementation of the second aspect of the present disclosure further includes determining a portion of the multiple predicting modes selected from the multiple IntraTMP mode candidates; determining multiple template matching cost values, each generated from one of the portion of the multiple predicting modes; and determining a portion of the multiple weighting factors for the portion of the multiple predicting modes based on the multiple template matching cost values.

In an implementation of the second aspect of the present disclosure, each of the multiple weighting factors corresponds to one of the multiple predicted blocks, and each of the multiple predicted blocks corresponds to one of the multiple weighting factors.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of this disclosure.

FIG. 2 is a block diagram illustrating a decoder module of the second electronic device illustrated in FIG. 1, in accordance with one or more example implementations of this disclosure.

FIG. 3 is a flowchart illustrating a method/process for decoding and/or encoding video data by an electronic device, in accordance with one or more example implementations of this disclosure.

FIG. 4A is a schematic illustration of a pair of partition areas and divided from a block unit along a split line, in accordance with one or more example implementations of this disclosure.

FIG. 4B is a schematic illustration of the block unit having geometric partitions separated based on the split line, in accordance with one or more example implementations of this disclosure.

FIG. 5 is a flowchart illustrating a method/process for decoding and/or encoding video data by an electronic device, in accordance with one or more example implementations of this disclosure.

FIG. 6 is a block diagram illustrating an encoder module of the first electronic device illustrated in FIG. 1, in accordance with one or more example implementations of this disclosure.

### DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

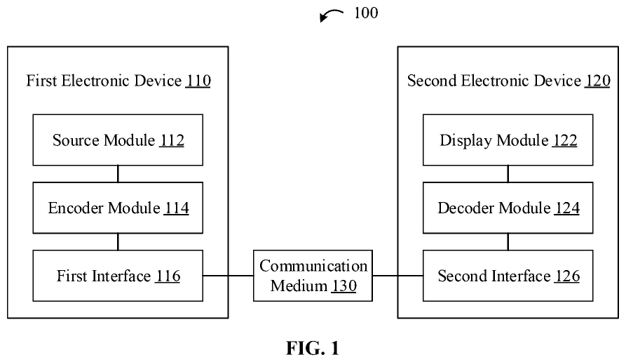

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

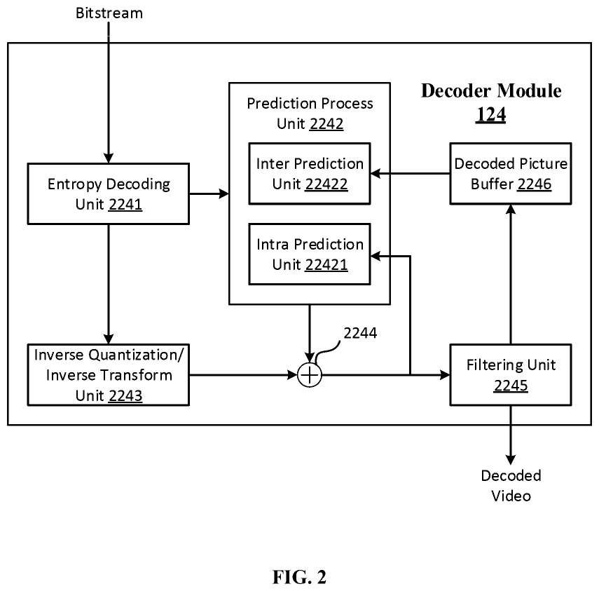

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit is reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block. The motion vector may indicate a displacement of the current block unit within the current image block relative to a reference block unit within the reference image block. The reference block unit may be a block determined to closely match the current block unit. The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block to the predicted block provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove blocking artifacts from the reconstructed block. Additional filters (in loop or post loop) may also be used in addition to the deblocking filter, the SAO filter, the bilateral filter, and the ALF. Such filters are not explicitly illustrated for brevity but may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any of a variety of memory devices, such as dynamic random-access memory (DRAM), including synchronous DRAM (SDRAM), magneto-resistive RAM (MRAM), resistive RAM (RRAM), or other types of memory devices. The decoded picture buffer 2246 may be on-chip with other components of the decoder module 124 or off-chip relative to those components.

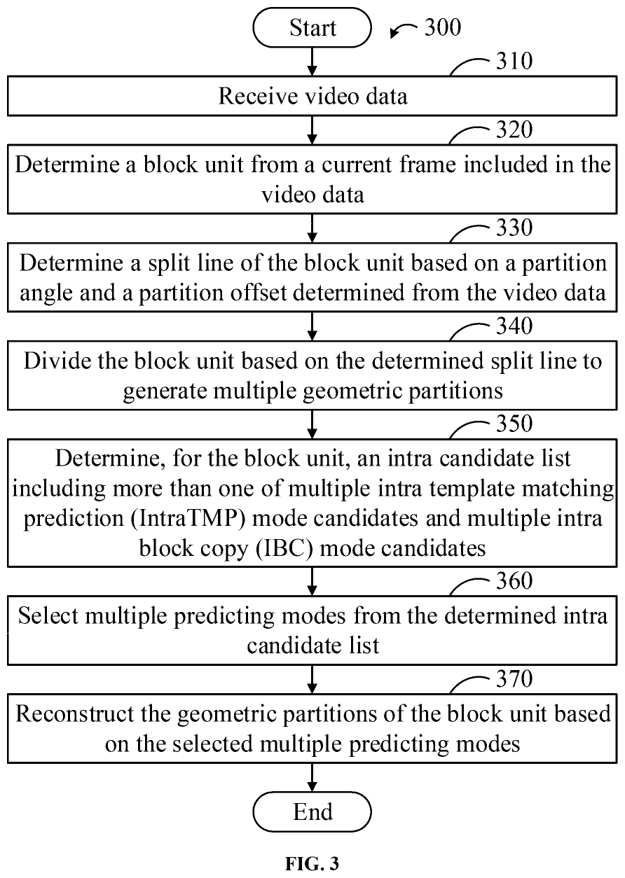

FIG. 3 is a flowchart illustrating a method/process 300 for decoding and/or encoding video data by an electronic device, in accordance with one or more example implementations of this disclosure. The method/process 300 is an example implementation, as there are a variety of ways of decoding the video data.

The method/process 300 may be performed by an electronic device using the configurations illustrated in FIGS. 1 and 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus may be different from what is illustrated. Additional blocks may be added or fewer blocks may be utilized without departing from the scope of the present disclosure.

At block 310, the method/process 300 may start by the decoder module 124 receiving the video data. The video data received by the decoder module 124 may include a bitstream.

With reference to FIGS. 1 and 2, the second electronic device 120 may receive the bitstream from an encoder, such as the first electronic device 110 (or other video providers) via the second interface 126. The second interface 126 may provide the bitstream to the decoder module 124.

At block 320, the decoder module 124 determines a block unit from a current frame included in the video data.

With reference to FIGS. 1 and 2, the decoder module 124 may determine the image frames included in the bitstream when the video data received by the decoder module 124 is the bitstream. The current frame may be one of the image frames determined according to the bitstream. The decoder module 124 may further divide the current frame to determine the block unit according to partition indications in the bitstream. For example, the decoder module 124 may divide the current frame to generate multiple CTUs, and further divide a current CTU included in the CTUs to generate multiple divided blocks and to determine the block unit from the divided blocks according to the partition indications based on any video coding standard. The size of the block unit may be Wb×Hb. In some implementations, the values Wb and Hb may be positive integers (e.g., 4, 8, etc.) that may be equal to, or different from, each other.

At block 330, the decoder module 124 determines a split line of the block unit based on a partition angle and a partition offset determined from the video data.

With reference to FIGS. 1 and 2, the decoder module 124 may determine the partition angle and the partition offset of the block unit based on the video data, and then determine the split line of the block unit based on the partition angle and the partition offset of the block unit.

In some implementations, an angle index and an offset index of the block unit may be included in the video data. The angle index of the block unit may indicate the partition angle of the split line of the block unit, and the offset index of the block unit may indicate the partition offset between the split line and a center point of the block unit. Thus, the decoder module 124 may determine the partition angle and the partition offset of the block unit directly based on the angle index and the offset index of the block unit included in the video data. In some implementations, the angle index may be a syntax element angleIdx, and the offset index may be a syntax element distanceIdx.

In some other implementations, a geometric partition index of the block unit may be included in the video data. The geometric partition index may simultaneously indicate the angle index and the offset index. Thus, the decoder module 124 may determine the partition angle and the partition offset of the block unit based on the geometric partition index of the block unit, and then determine the split line of the block unit based on the partition angle and the partition offset of the block unit. In some implementations, the geometric partition index may be a syntax element gpmii_partition_idx. In yet other implementations, another geometric partition index of the block unit may be included in the video data. The geometric partition index may simultaneously indicate the split line and multiple predicting modes of the block unit.

At block 340, the decoder module 124 divides the block unit based on the determined split line to generate multiple geometric partitions.

With reference to FIGS. 1 and 2, the decoder module 124 may divide the block unit based on the determined split line to generate multiple partition areas, and further determines the geometric partitions based on the partition areas. For example, the decoder module 124 may further divide the partition areas based on at least one blending width for generating the geometric partitions. The decoder module 124 may determine the at least one blending width from multiple candidate widths. In some implementations, the at least one blending width may be selected from the candidate widths by parsing at least one width index indicating the at least one blending width of the block unit. In some implementations, the at least one blending width may be predefined without parsing any width index. In some implementations, the candidate widths may include 0, τ/4, τ/2, τ, 2τ, and 4τ. The number t may be equal to 2, 4, or other positive integers. For example, the number t may be predefined as being equal to 2.

In some implementations, when the number of the at least one blending width is equal to one, one width index may be determined from the video data to indicate one blending width of the block unit. In some other implementations, when the number of the at least one blending width is equal to two, two width indices may be determined from the video data to indicate two blending widths of the block unit. For example, a first width index may indicate a first blending width BW1 for a first side of the determined split line, and a second width index may indicate a second blending width BW2 for a second side of the determined split line. In some implementations, the two width indices may be different from each other, so the first blending width BW1 may be different from the second blending width BW2. In addition, the two width indices may be identical to each other, so the first blending width BW1 may be identical to the second blending width BW2.

The at least one blending width may be used to determine multiple blending lines based on the determined split line. When the blending lines are determined, the decoder module 124 may determine the geometric partitions based on the blending lines. In some implementations, the number of the geometric partitions may be equal to three when the number of the blending lines is equal to two. In some implementations, a first geometric partition may be located at the first side of the split line, the second geometric partition may be located at the second side of the split line, and the third geometric partition covering the split line may be sandwiched between the first and second geometric partitions. A first partition size of the first geometric partition may be determined based on the first blending width BW1, a second partition size of the second geometric partition may be determined based on the second blending width BW2. In some implementations, a third partition size of the third geometric partition may be determined based on the first and second blending widths BW1 and BW2. In some other implementations, the third partition size of the third geometric partition may be determined based on one the first and second blending widths BW1 and BW2 when the first and second blending widths BW1 and BW2 is equal to each other.

In some implementations, the first side of the determined split line may be a left side of the determined split line and the second side of the determined split line may be a right side of the determined split line. In some other implementations, the first side of the determined split line may be the right side of the determined split line and the second side of the determined split line may be the left side of the determined split line. In some implementations, the first side of the determined split line may be determined based on a syntax flag included in the video data.

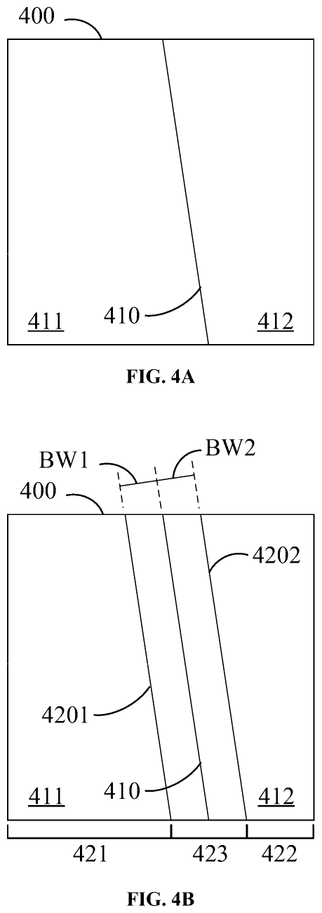

FIG. 4A is a schematic illustration of a pair of partition areas 411 and 412 divided from a block unit 400 along a split line 410, in accordance with one or more example implementations of this disclosure. In some implementations, the block unit 400 may include multiple block samples. The block samples in the block unit 400 may be divided into the partition areas 411 and 412 based on the split line 410. In some implementations, the number of the partition areas may be equal to two.

FIG. 4B is a schematic illustration of the block unit 400 having geometric partitions 421-423 separated based on the split line 410, in accordance with one or more example implementations of this disclosure. In some implementations, the decoder module 124 may divide the block unit 400 based on the split line 410 and multiple blending lines 4201 and 4202 to determine the geometric partitions 421-423. In some implementations, the decoder module 124 may generate the blending lines 4201 and 4202 based on the split line 410 and the at least one blending width. When the number of the at least one blending width is equal to one, the first blending width BW1 between the blending line 4201 and the split line 410 may be identical to the second blending width BW2 between the blending line 4202 and the split 410. In addition, when the number of the at least one blending width is equal to two, the first blending width BW1 between the blending line 4201 and the split line 410 may be equal to or different from the second blending width BW2 between the blending line 4202 and the split 410. Thus, the decoder module 124 may divide the block unit 400 to generate the geometric partitions 421-423 based on the at least one blending width. In some implementations, the first geometric partition 421 may be located at the first side of the split line 410, the second geometric partition 422 may be located at the second side of the split line 410, and the third geometric partition 423 may cover the split line 410.

In some implementations, the first partition area 411 may be separated from the second partition area 412 by the split line 410. In addition, the first geometric partition 421 may be included in the first partition area 411 and the second geometric partition 422 may be included in the second partition area 412. A portion of the third geometric partition 423 may be included in the first partition area 411, and the other portion of the third geometric partition 423 may be included in the second partition area 412. The third geometric partition 423 may separate the first geometric partition 421 from the second geometric partition 422. The first geometric partition 421 may be separated from the third geometric partition 423 by the blending line 4201, and the second geometric partition 422 may be separated from the third geometric partition 423 by the blending line 4202.

At block 350, the decoder module 124 determines, for the block unit, an intra candidate list including more than one of multiple intra template matching prediction (IntraTMP) mode candidates and multiple intra block copy (IBC) mode candidates.

With reference to FIGS. 1 and 2, the decoder module 124 may determine the IntraTMP mode candidates and the IBC mode candidates of the block unit. In some implementations, the decoder module 124 may add all of the IntraTMP mode candidates and the IBC mode candidates into the intra candidate list. In some other implementations, the decoder module 124 may add a portion of the IntraTMP mode candidates and the IBC mode candidates into the intra candidate list. The number of the portion of the IntraTMP mode candidates and the IBC mode candidates may be greater than 1. In some implementations, the portion of the IntraTMP mode candidates and the IBC mode candidates included in the intra candidate list may be selected only from the IntraTMP mode candidates. In some other implementations, the portion of the IntraTMP mode candidates and the IBC mode candidates in the intra candidate list may include at least one of the IntraTMP mode candidates and at least one of the IBC mode candidates. In some other implementations, the intra candidate list may further include at least one of multiple non-block vector based (non-BV-based) mode candidates.

The IBC mode candidates may be selected from multiple regular IBC merge mode candidates, multiple IBC-merge mode with block vector differences (IBC-MBVD) mode candidates, multiple IBC-template matching (IBC-TM) mode candidates, and multiple IBC-advanced motion vector prediction (IBC-AMVP) mode candidates. Each of the IBC mode candidates may include an IBC vector indicating an IBC reference block for predicting and reconstructing the block unit. The IBC vectors of the regular IBC merge mode candidates may be derived using a regular IBC merge prediction mode. The IBC vectors of the IBC-MBVD mode candidates may be derived using an IBC-MBVD prediction mode. The IBC vectors of the IBC-TM mode candidates may be derived using an IBC-TM prediction mode. The IBC vectors of the IBC-AMVP mode candidates may be derived using an IBC-AMVP prediction mode.

The IntraTMP mode candidates may be derived using an IntraTMP prediction mode. The decoder module 124 may determine a template region neighboring the block unit and search multiple IntraTMP reference blocks from a search region of the block unit. Each of the IntraTMP reference blocks may respectively have a reference region. The decoder module 124 may compare the template region with the reference regions to select the IntraTMP mode candidates from the IntraTMP reference blocks.

Each of the non-BV-based mode candidates may indicate a corresponding one of multiple conventional intra modes. The non-BV-based mode candidates may be respectively derived based on spatial candidates, the split line of the block unit, multiple template-based intra mode derivation (TIMD) mode candidate, and multiple decoder-side intra mode derivation (DIMD) mode candidates. For example, the non-BV-based mode candidates may be multiple most probable modes (MPMs) derived based on multiple neighboring modes of multiple neighboring blocks.

At block 360, the decoder module 124 selects multiple predicting modes from the determined intra candidate list.

With reference to FIGS. 1 and 2, in some implementations, the decoder module 124 may select the predicting modes from the determined intra candidate list including the more than one of the IntraTMP mode candidates and the IBC mode candidates. A first one of the predicting modes may be a first one of the IntraTMP mode candidates included in the determined intra candidate list. In some implementations, the first IntraTMP mode candidate in the determined intra candidate list may be arbitrary IntraTMP mode candidate, not necessarily the first IntraTMP mode candidate listed in order. A second one of the predicting modes may be selected from the IntraTMP mode candidates and the IBC mode candidates included in the determined intra candidate list. In addition, the second predicting mode may be different from the first predicting mode.

In some other implementations, the decoder module 124 may select the predicting modes from the determined intra candidate list including the more than one of the IntraTMP mode candidates and the IBC mode candidates and the at least one of the non-BV-based mode candidates. In some implementations, when a first one of the predicting modes may be a first one of the IntraTMP mode candidates, and a second one of the predicting modes different from the first one of the predicting modes may be any other one of the mode candidates in the determined intra candidate list. In some other implementations, when the first one of the predicting modes may be a first one of the IBC mode candidates, and the second one of the predicting modes may be a first one of the at least one non-BV-based mode candidates.

The number of the predicting modes may be equal to two. The first predicting mode may be used to predict the first geometric partition. A second one of the predicting modes may be used to predict the second geometric partition. The third geometric partition may be predicted using both of the first predicting mode and the second predicting mode when the number of the geometric partitions is equal to three.

In some implementations, when the first predicting mode is the first one of the IntraTMP mode candidates and the second predicting mode is a second one of the IntraTMP mode candidates included in the determined intra candidate list, the third geometric partition may be predicted using the first IntraTMP mode candidate and the second IntraTMP mode candidate included in the determined intra candidate list. In addition, the second IntraTMP mode candidate may be different from the first IntraTMP mode candidate. In some implementations, the first and second IntraTMP mode candidates in the determined intra candidate list may be arbitrary two different IntraTMP mode candidates, not necessarily the first two IntraTMP mode candidates listed in order.

In some other implementations, when the first predicting mode is the first one of the IntraTMP mode candidates and the second predicting mode is a first one of the IBC mode candidates included in the determined intra candidate list, the third geometric partition may be predicted using the first IntraTMP mode candidate and the first IBC mode candidate included in the determined intra candidate list. In some implementations, the first IBC mode candidate in the determined intra candidate list may be arbitrary IBC mode candidate, not necessarily the first IBC mode candidate listed in order.

In some other implementations, when the first predicting mode is the first one of the IntraTMP mode candidates and the second predicting mode is a first one of the at least one non-BV-based mode candidates included in the determined intra candidate list, the third geometric partition may be predicted using the first IntraTMP mode candidate and the first non-BV-based mode candidate included in the determined intra candidate list. In some implementations, the first non-BV-based mode candidate in the determined intra candidate list may be arbitrary non-BV-based mode candidate, not necessarily the first non-BV-based mode candidate listed in order. In yet other implementations, when the first predicting mode is the first one of the IBC mode candidates and the second predicting mode is the first one of the at least one non-BV-based mode candidates included in the determined intra candidate list, the third geometric partition may be predicted using the first IBC mode candidate and the first non-BV-based mode candidate included in the determined intra candidate list.

The predicting modes may be selected based on zero or more mode candidate index. In some implementations, the predicting modes may be selected based on multiple mode candidate indices. In some implementations, the mode candidate indices may include multiple intra candidate indices respectively used to select one of the predicting modes from the determined intra candidate list. In some other implementations, the mode candidate indices may include an IntraTMP candidate index used to select the first IntraTMP mode candidate only from the IntraTMP mode candidates in the determined intra candidate list and one intra candidate index used to select the second predicting mode from the IntraTMP mode candidates, the IBC mode candidates, and the at least one non-BV-based mode candidate in the determined intra candidate list when the first predicting mode is the first intraTMP mode candidate. In some other implementations, when the first predicting mode is the first intraTMP mode candidate and the second predicting mode is the first IBC mode candidate, the mode candidate indices may include an IntraTMP candidate index used to select the first IntraTMP mode candidate only from the IntraTMP mode candidates in the determined intra candidate list and an IBC candidate index used to select the first IBC mode candidate only from the IBC mode candidates in the determined intra candidate list. In some other implementations, when the first predicting mode is the first intraTMP mode candidate and the second predicting mode is the second IntraTMP mode candidate, the mode candidate indices may include two IntraTMP candidate indices used to select the first and second IntraTMP mode candidates only from the IntraTMP mode candidates in the determined intra candidate list. In some other implementations, when the first predicting mode is the first intraTMP mode candidate and the second predicting mode is the first non-BV-based mode candidate, the mode candidate indices may include the IntraTMP candidate index used to select the first IntraTMP mode candidate only from the IntraTMP mode candidates in the determined intra candidate list and a non-BV-based candidate index used to select the first non-BV-based mode candidate only from the non-BV-based mode candidates in the determined intra candidate list. In yet other implementations, when the first predicting mode is the first IBC mode candidate and the second predicting mode is the first non-BV-based mode candidate, the mode candidate indices may include the IBC candidate index used to select the first IBC mode candidate only from the IBC mode candidates in the determined intra candidate list and the non-BV-based candidate index used to select the first non-BV-based mode candidate only from the non-BV-based mode candidates in the determined intra candidate list.

In some other implementations, the predicting modes may be selected based on one mode candidate index. When the first predicting mode is selected from the IntraTMP mode candidates, a specific one of the IntraTMP mode candidates having the lowest one of multiple template matching cost values of the IntraTMP mode candidates may be predefined to be selected as the first predicting mode. Thus, the specific IntraTMP mode candidate having the lowest template matching cost value may be selected as the first predicting mode based on the template matching cost values of the IntraTMP mode candidates without determining the mode candidate index from the video data. In some implementations, the mode candidate index may include an intra candidate index used to select the second predicting mode from the determined intra candidate list. In some other implementations, when the second predicting mode is the first IBC mode candidate, the mode candidate index may be one IBC candidate index used to select the first IBC mode candidate only from the IBC mode candidates in the determined intra candidate list. In some other implementations, when the second predicting mode is the first non-BV-based mode candidate, the mode candidate index may be one non-BV-based candidate index used to select the first non-BV-based mode candidate only from the non-BV-based mode candidates in the determined intra candidate list. In yet other implementations, when the second predicting mode is the second IntraTMP mode candidate, the mode candidate index may include one IntraTMP candidate index used to select the other predicting mode only from the IntraTMP mode candidates in the determined intra candidate list. In addition, when the first predicting mode is selected from the IBC mode candidates, a specific one of the IBC mode candidates having the lowest one of multiple template matching cost values of the IBC mode candidates may be predefined to be selected as the first predicting mode. Thus, the specific IBC mode candidate having the lowest template matching cost value may be selected as the first predicting mode based on the template matching cost values of the IBC mode candidates without determining the mode candidate index from the video data. Furthermore, the mode candidate index may include an intra candidate index used to select the second predicting mode only from the non-BV-based mode candidates in the determined intra candidate list.

In yet other implementations, in the video data, there may be no mode candidate index used to select the predicting modes. In some implementations, the decoder module 124 may calculate the template matching cost values of the IntraTMP mode candidates and the IBC mode candidates and directly select the predicting modes based on the template matching cost values. For example, two specific ones of the mode candidates having the lowest two of the template matching cost values of the mode candidates in the determined intra candidate list may be predefined as the predicting modes. In some other implementations, the decoder module 124 may calculate the template matching cost values of the IntraTMP mode candidates, the IBC mode candidates, and the non-BV-based mode candidates and directly select the predicting modes based on the template matching cost values. In yet other implementations, the mode candidate indices may be indicated by the geometric partition index. Thus, when the decoder may simultaneously determine the split line and the predicting modes based on the geometric partition index without parsing the mode candidate indices from the video data.

At block 370, the decoder module 124 reconstructs the geometric partitions of the block unit based on the selected multiple predicting modes.

With reference to FIGS. 1 and 2, the decoder module 124 may reconstruct the geometric partitions respectively based on at least one of the selected predicting modes. Each of the geometric partitions in the block unit may be reconstructed using at least one of the selected predicting modes.

The first predicting mode may be used to predict the first geometric partition to generate a first predicted partition, and the second predicting mode may be used to predict the second geometric partition to generate a second predicted partition. The predicting modes may be used to predict the third geometric partition to generate a third predicted partition. The decoder module 124 may combine the first to third predicted partitions to generate a prediction block of the block unit.

The third geometric partition may be predicted based on the at least one blending width. The decoder module 124 may generate a first predicted sub-partition for the third geometric partition based on the first predicting mode, and generate a second predicted sub-partition for the third geometric partition based on the second predicting mode. The decoder module 124 may weightedly combine the first predicted sub-partition and the second predicted sub-partition to generate the third predicted partition based on the at least one blending width.

The decoder module 124 may reconstruct the block unit based on the predicted block. The decoder module 124 may determine multiple residual components from the bitstream for the block unit and add the residual components into the predicted block to reconstruct the block unit. The decoder module 124 may reconstruct all of the other block units in the image frame for reconstructing the image frame and the video. The method/process 300 may then end.

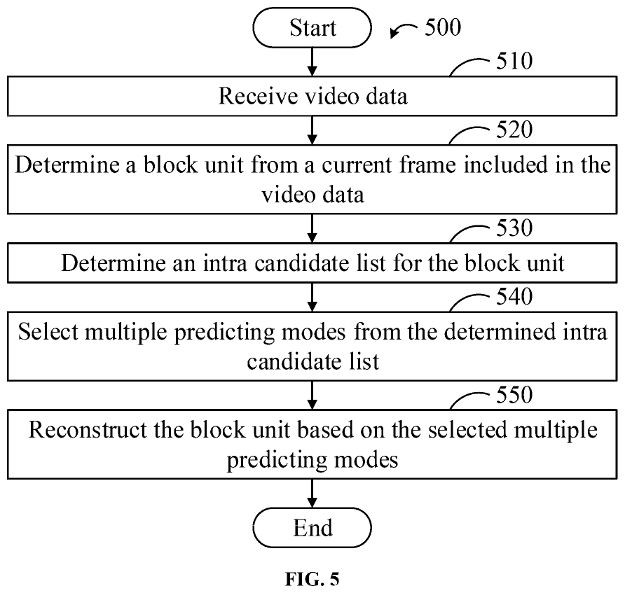

FIG. 5 is a flowchart illustrating a method/process 500 for decoding and/or encoding video data by an electronic device, in accordance with one or more example implementations of this disclosure. The method/process 500 is an example implementation, as there are a variety of ways of decoding the video data.

The method/process 500 may be performed by an electronic device using the configurations illustrated in FIGS. 1 and 2, where various elements of these figures may be referenced to describe the method/process 500. Each block illustrated in FIG. 5 may represent one or more processes, methods, or subroutines performed by an electronic device.

The order in which the blocks appear in FIG. 5 is for illustration only, and may not be construed to limit the scope of the present disclosure, thus may be different from what is illustrated. Additional blocks may be added or fewer blocks may be utilized without departing from the scope of the present disclosure.

At block 510, the method/process 500 may start by the decoder module 124 receiving the video data. The video data received by the decoder module 124 may include a bitstream.

With reference to FIGS. 1 and 2, the second electronic device 120 may receive the bitstream from an encoder, such as the first electronic device 110 (or other video providers) via the second interface 126. The second interface 126 may provide the bitstream to the decoder module 124.

At block 520, the decoder module 124 determines a block unit from a current frame included in the video data.

With reference to FIGS. 1 and 2, the decoder module 124 may determine the image frames included in the bitstream when the video data received by the decoder module 124 is the bitstream. The current frame may be one of the image frames determined according to the bitstream. The decoder module 124 may further divide the current frame to determine the block unit according to partition indications in the bitstream. For example, the decoder module 124 may divide the current frame to generate multiple CTUs, and further divide a current CTU included in the CTUs to generate multiple divided blocks and to determine the block unit from the divided blocks according to the partition indications based on any video coding standard. The size of the block unit may be Wb×Hb. In some implementations, the values Wb and Hb may be positive integers (e.g., 4, 8, etc.) that may be equal to, or different from, each other.

At block 530, the decoder module 124 determines an intra candidate list for the block unit.

With reference to FIGS. 1 and 2, the decoder module 124 may determine multiple mode candidates including multiple intra template matching prediction (IntraTMP) mode candidates, multiple intra block copy (IBC) mode candidates, and multiple decoder-side intra mode derivation (DIMD) mode candidates of the block unit. The decoder module 124 may determine the intra candidate list of the block unit from the IntraTMP mode candidates, the IBC mode candidates, and the DIMD mode candidates of the block unit. Thus, the intra candidate list of the block unit may include more than one of the IntraTMP mode candidates, the IBC mode candidates, and the DIMD mode candidates of the block unit. The IntraTMP mode candidates may be generated using an IntraTMP prediction mode. The IBC mode candidates may be generated using an IBC prediction mode. The DIMD mode candidates may be generated using a DIMD prediction mode.

In some implementations, the decoder module 124 may add all of the IntraTMP mode candidates, the IBC mode candidates, and the DIMD mode candidates into the intra candidate list. In some other implementations, the decoder module 124 may add a portion of the IntraTMP mode candidates, the IBC mode candidates, and the DIMD mode candidates into the intra candidate list. The number of the portion of the IntraTMP mode candidates, the IBC mode candidates, and the DIMD mode candidates may be greater than 1.

The intra candidate list may be generated based on two different ones of the IntraTMP prediction mode, the IBC prediction mode, and the DIMD prediction mode. In some implementations, the decoder module 124 may determine the intra candidate list of the block unit only from the IBC mode candidates and the DIMD mode candidates of the block unit. In other words, when the intra candidate list includes all or a portion of the IBC mode candidates, the intra candidate list may further include all or a portion of the DIMD mode candidates and include none of the IntraTMP mode candidates. In some other implementations, the decoder module 124 may determine the intra candidate list of the block unit only from the IntraTMP mode candidates and the IBC mode candidates of the block unit. In other words, when the intra candidate list includes all or a portion of the IntraTMP mode candidates, the intra candidate list may further include all or a portion of the IBC mode candidates and include none of the DIMD mode candidates. In yet other implementations, the decoder module 124 may determine the intra candidate list of the block unit only from the DIMD mode candidates and the IntraTMP mode candidates of the block unit. In other words, when the intra candidate list includes all or a portion of the DIMD mode candidates, the intra candidate list may further include all or a portion of the IntraTMP mode candidates and include none of the IBC mode candidates.

The IBC mode candidates may be generated using an IBC prediction mode. The IBC mode candidates may be selected from multiple regular IBC merge mode candidates, multiple IBC-merge mode with block vector differences (IBC-MBVD) mode candidates, multiple IBC-template matching (IBC-TM) mode candidates, and multiple IBC-advanced motion vector prediction (IBC-AMVP) mode candidates. Each of the IBC mode candidates may include an IBC vector indicating an IBC reference block for predicting and reconstructing the block unit. The IBC vectors of the regular IBC merge mode candidates may be derived using a regular IBC merge prediction mode. The IBC vectors of the IBC-MBVD mode candidates may be derived using an IBC-MBVD prediction mode. The IBC vectors of the IBC-TM mode candidates may be derived using an IBC-TM prediction mode. The IBC vectors of the IBC-AMVP mode candidates may be derived using an IBC-AMVP prediction mode.

The IntraTMP mode candidates may be derived using an IntraTMP prediction mode. The decoder module 124 may determine a template region neighboring the block unit and search multiple IntraTMP reference blocks from a search region of the block unit. Each of the IntraTMP reference blocks may respectively have a reference region. The decoder module 124 may compare the template region with the reference regions to select the IntraTMP mode candidates from the IntraTMP reference blocks.

The DIMD mode candidates may be generated using a DIMD prediction mode. The decoder module 124 may derive a histogram of oriented gradient (HoG) based on multiple neighboring samples in a reference region neighboring the block unit. The DIMD mode candidates may be derived based on the HoG. Each of the DIMD mode candidates may be generated by the Planar mode and at least one of multiple regular angular modes selected based on multiple amplitudes in the HoG. The at least one selected regular angular mode may be included in the primary list of intra most probable modes (MPM) of the block unit. A region size and a region shape of the DIMD mode candidates may be predefined. In some implementations, when the intra prediction list includes the DIMD mode candidates and the IntraTMP mode candidates, the region size and the region shape of the reference regions of the DIMD mode candidates may be identical to or different from those of the template regions of the IntraTMP mode candidates.

At block 540, the decoder module 124 selects multiple predicting modes from the determined intra candidate list.

The predicting modes may be divided into a first predicting group and a second predicting group. With reference to FIGS. 1 and 2, the decoder module 124 may select at least one first predicting mode in the first predicting group and at least one second predicting mode in the second predicting group from the determined intra candidate list. The at least one first predicting mode and the at least one second predicting mode may be generated using two different ones of the IntraTMP prediction mode, the IBC prediction mode, and the DIMD prediction mode. In other words, when the at least one first predicting mode in the first predicting group is generated using one of the IntraTMP prediction mode, the IBC prediction mode, and the DIMD prediction mode, the at least one second predicting mode in the second predicting group may be generated using another one of the IntraTMP prediction mode, the IBC prediction mode, and the DIMD prediction mode. The number of the at least one first predicting mode may be equal to one, two, or other positive integers, and the number of the at least one second predicting mode may be equal to one, two, or other positive integers. The number of the at least one first predicting mode may be equal to or different from the number of the at least one second predicting mode.

A first one of the predicting modes may be included in the first predicting group, and a second one of the predicting modes may be included in the second predicting group. Thus, the first and second of the predicting modes may be generated using two different one of the IntraTMP prediction mode, the IBC prediction mode, and the DIMD prediction mode.

In some implementations, when the at least one first predicting mode is selected from the IntraTMP mode candidates, each of the at least one second predicting mode may be selected from the DIMD mode candidates. In some other implementations, when the at least one first predicting mode is selected from the IntraTMP mode candidates, each of the at least one second predicting mode may be selected from the IBC mode candidates. For example, the second predicting mode may be generated using one of the IBC prediction mode and the DIMD prediction mode when the first predicting mode is generated using the IntraTMP prediction mode.

In some implementations, when the at least one first predicting mode is selected from the DIMD mode candidates, each of the at least one second predicting mode may be selected from the IBC mode candidates. In some other implementations, when the at least one first predicting mode is selected from the DIMD mode candidates, each of the at least one second predicting mode may be selected from the IntraTMP mode candidates. For example, the second predicting mode may be generated using one of the IntraTMP prediction mode and the IBC prediction mode when the first predicting mode is generated using the DIMD prediction mode.

In some implementations, when the at least one first predicting mode is selected from the IBC mode candidates, each of the at least one second predicting mode may be selected from the IntraTMP mode candidates. In some other implementations, when the at least one first predicting mode is selected from the IBC mode candidates, each of the at least one second predicting mode may be selected from the DIMD mode candidates. For example, the second predicting mode may be generated using one of the DIMD prediction mode and the IntraTMP prediction mode when the first predicting mode is generated using the IBC prediction mode.

In some implementations, one of the first and second predicting groups may be an IntraTMP predicting group generated by determining at least one of the IntraTMP mode candidates from the intra candidate list as at least one IntraTMP predicting mode. In some implementations, the at least one IntraTMP predicting mode may be selected from the IntraTMP mode candidates based on at least one IntraTMP prediction index. In some other implementations, the at least one IntraTMP predicting mode may be selected from the IntraTMP mode candidates based on multiple template matching cost values of the IntraTMP mode candidates without parsing the at least one IntraTMP prediction index. For example, when the number of the at least one IntraTMP predicting modes is equal to K, the decoder module 124 may select K IntraTMP mode candidates having the lowest K of the template matching cost values as K IntraTMP predicting modes. The number K may be equal to one, two, or other positive integers. In yet other implementations, one part of the at least one IntraTMP predicting mode may be selected from the IntraTMP mode candidates based on at least one IntraTMP prediction index, while the other part of the at least one IntraTMP predicting mode may be selected from the IntraTMP mode candidates based on the template matching cost values of the IntraTMP mode candidates without parsing the at least one IntraTMP prediction index.

In some implementations, one of the first and second predicting groups may be an IBC predicting group generated by determining at least one of the IBC mode candidates from the intra candidate list as at least one IBC predicting mode. In some implementations, the at least one IBC predicting mode may be selected from the IBC mode candidates based on at least one IBC prediction index. In some other implementations, a selection scheme of the at least one IBC predicting mode may be predefined without parsing the at least one IBC prediction index. In yet other implementations, one part of the at least one IBC predicting mode may be selected from the IBC mode candidates based on at least one IBC prediction index, while the other part of the at least one IBC predicting mode may be selected based on the selection scheme without parsing the at least one IBC prediction index.

In some implementations, one of the first and second predicting groups may be a DIMD predicting group generated by determining at least one of the DIMD mode candidates from the intra candidate list as at least one DIMD predicting mode. In some implementations, the at least one DIMD predicting mode may be selected from the DIMD mode candidates based on at least one DIMD prediction index. In some other implementations, the at least one DIMD predicting mode may be selected from the DIMD mode candidates based on the amplitude of the HoG without parsing any index. For example, when the number of the at least one DIMD predicting modes is equal to R, the decoder module 124 may select R DIMD mode candidates having the highest R of the amplitude as R DIMD predicting modes. The number R may be equal to one, two, or other positive integers. In yet other implementations, one part of the at least one DIMD predicting mode may be selected from the DIMD mode candidates based on at least one DIMD prediction index, while the other part of the at least one DIMD predicting mode may be selected from the DIMD mode candidates based on the amplitude in the HoG without parsing the at least one DIMD prediction index.

At block 550, the decoder module 124 reconstructs the block unit based on the selected multiple predicting modes.

With reference to FIGS. 1 and 2, the decoder module 124 may predict the block unit using each of the predicting modes to respectively generate one of multiple predicted blocks. Each of the predicted blocks may be generated based on a corresponding one of the predicting modes. In other words, each of the predicted blocks may correspond to the predicting modes one-to-one. Furthermore, the decoder module 124 may determine multiple weighting factors for the predicted blocks. Each of the weighting factors may correspond to one of the predicted blocks, and each of the predicted blocks may correspond to one of the weighting factors. Thus, each of the predicted blocks may also correspond to the weighting factors one-to-one.

The decoder module 124 may further weightedly combine the predicted blocks based on the weighting factors to generate a prediction block of the block unit, and reconstruct the block unit based on the prediction block of the block unit. The prediction block may be generated based on the following functions:

$$P = {\sum }_{i = 1}^{T} {W}_{i} \times {P}_{i}$$

where P is a prediction value, T is the number of the predicting modes, Pᵢ is a predicted value in an i-th predicted block, and Wᵢ is an i-th weighting factor of the i-th predicted block. In some implementations, each of the IntraTMP predicted blocks generated using a corresponding one of the IntraTMP predicting modes may have a corresponding one of multiple IntraTMP weighting factors W_{intraTMP_x}. In some implementations, each of the IBC predicted blocks generated using a corresponding one of the IBC predicting modes may have a corresponding one of multiple IBC weighting factors W_{IBC_y}. In some implementations, each of the DIMD predicted blocks generated using a corresponding one of the DIMD predicting modes may have a corresponding one of multiple DIMD weighting factors W_{DIMD_z}.

The decoder module 124 may determine multiple neighboring blocks neighboring the block unit. Each of the neighboring blocks may be reconstructed prior to reconstructing the block unit. Thus, the weighting factors of the block unit may be derived based on coded data of the neighboring blocks. The coded data may include multiple neighboring sizes, multiple neighboring modes, and multiple neighboring vectors (e.g., motion vectors and block vectors) of the neighboring blocks.

Each of the neighboring blocks may be predicted based on a corresponding one of the neighboring modes. The weighting factors may be determined based on whether the neighboring modes are generated using the IntraTMP prediction mode, the IBC prediction mode, and the DIMD prediction mode.

The decoder module 124 may calculate the quantity of neighboring modes generated using each of the IntraTMP prediction mode, the IBC prediction mode, and the DIMD prediction mode, respectively, and compare the quantities to determine the weighting factors. For example, the decoder module may categorize the neighboring modes into a first to third neighboring group. The neighboring modes included in the first neighboring group may be generated using a first specific prediction mode, and the neighboring modes included in the second neighboring group may be generated using a second specific prediction mode. The first specific prediction mode may be one of the IntraTMP prediction mode, the IBC prediction mode, and the DIMD prediction mode, and the second specific prediction mode may be another one of the IntraTMP prediction mode, the IBC prediction mode, and the DIMD prediction mode. In addition, the neighboring modes included in the third neighboring group may be generated using other prediction modes different from the IntraTMP prediction mode, the IBC prediction mode, and the DIMD prediction mode. In some implementations, the first specific prediction mode may be identical to a prediction mode used to generate the at least one first predicting mode in the first predicting group. In addition, the second specific prediction mode may be identical to another prediction mode used to generate the at least one second predicting mode in the second predicting group.

The decoder module 124 may compare the quantity of the neighboring modes included in the first neighboring group with the quantity of the neighboring modes included in the second neighboring group. When the quantity of the neighboring modes included in the first neighboring group is greater than the quantity of the neighboring modes included in the second neighboring group, the weighting factors of the predicting modes generated by using the first specific prediction mode may be greater than the weighting factors of the predicting modes generated by using the second specific prediction mode. For example, when the quantity of the neighboring modes generated using the IBC prediction mode is greater than the quantity of the neighboring modes generated using the DIMD prediction mode, the IBC weighting factors of the IBC predicting modes may be greater than the DIMD weighting factors of the DIMD predicting modes.

The decoder module 124 may determine two neighboring blocks neighboring the block unit. A first neighboring block having a first neighboring mode may be located above block unit, and a second neighboring block having a second neighboring block may be located at a left side of the block unit. The first neighboring block may be located at a left side of a right boundary of the block unit, and the second neighboring block may be located above a bottom boundary of the block unit. In addition, the first neighboring block may be adjacent to a top-right corner of the block unit, and the second neighboring block may be adjacent to a bottom-left corner of the block unit. The decoder module 124 may determine whether the first and second neighboring modes are generated using the first specific prediction mode.

When the number of the predicting modes is equal to two, the decoder module 124 may directly determine the weighting factors based on the first and second neighboring modes. In addition, the first predicting mode may be generated using the first specific prediction mode, and the second predicting mode may be generated using the second specific prediction mode. The first specific prediction mode may be one of the IntraTMP prediction mode, the IBC prediction mode, and the DIMD prediction mode, and the second specific prediction mode may be another one of the IntraTMP prediction mode, the IBC prediction mode, and the DIMD prediction mode.

When the first neighboring mode is generated using the first specific prediction mode, the decoder module 124 may determine a variable ismodeTop as TRUE. When the first neighboring mode is not generated using the first specific prediction mode, the decoder module 124 may determine a variable ismodeTop as FALSE. When the second neighboring mode is generated using the first specific prediction mode, the decoder module 124 may determine a variable ismodeLeft as TRUE. When the second neighboring mode is not generated using the first specific prediction mode, the decoder module 124 may determine a variable ismodeLeft as FALSE. When both of the variables ismodeTop and ismodeLeft are TRUE, the weighting factor of the first predicting mode may be equal to three and the weighting factor of the second predicting mode may be equal to one. When both of the variables ismodeTop and ismodeLeft are FALSE, the weighting factor of the first predicting mode may be equal to one and the weighting factor of the second predicting mode may be equal to three. When one of the variables ismodeTop and ismodeLeft is TRUE and the other is FALSE, the weighting factor of the first predicting mode may be equal to two and the weighting factor of the second predicting mode may be equal to two. The prediction block may be generated based on the following functions:

$$P = ( {W}_{1} \times {P}_{1} + {W}_{2} \times {P}_{2} + 2 ) ≫ 2$$

where P is a prediction value, P₁ is a predicted value in the first predicted block generated based on the first predicting mode, P₂ is a predicted value in the second predicted block generated based on the second predicting mode, and W₁ and W₂ are two weighting factors of the first and the second predicting modes. The operator >> indicates a right shift operation. In some implementations, when the decoder module 124 determines whether the first and second neighboring modes are generated using the DIMD prediction mode (i.e. the first specific prediction mode is the DIMD prediction mode), the first specific prediction mode may further include at least one of the Planar mode, the DC mode, and other regular angular modes to increase the probability that the determination result is TRUE.

When the number of the predicting modes is equal to two, the first predicting mode may be generated using the first specific prediction mode and the second predicting mode may be generated using the second specific prediction mode. The prediction block may be generated based on the following functions:

$$P = ( {W}_{1} \times {P}_{1} + ( ( 1 ≪ shift ) - {W}_{1} ) \times {P}_{2} + ( 1 ≪ ( shift - 1 ) ) ) ≫ shift$$

where P is a prediction value, P₁ is a predicted value in the first predicted block generated based on the first predicting mode, P₂ is a predicted value in the second predicted block generated based on the second predicting mode, W₁ is a weighting factor of the first predicting mode, and shift is a shift value for a shift operation. The operator >> indicates the right shift operation, and the operator << indicates the left shift operation. In some implementations, when the weighting factor W₁ of the first predicting mode is equal to 13, the shift value shift may be equal to 4. In some other implementations, when the weighting factor W₁ of the first predicting mode is equal to 1, the shift value shift may be equal to 1. It should be noted that the shift value shift and the weighting factor W₁ of the first predicting mode may be changed without departing from the scope of the present disclosure.

In some implementations, the first specific prediction mode may be the DIMD prediction mode, and the first predicting mode is the DIMD predicting mode. When the first predicting mode is one of the Planar mode and the DC mode and both of the first and second neighboring modes are included in the intra regular modes (including the Planar mode, the DC mode, and the regular angular modes), the weighting factor W₂ of the second predicting mode may be equal to one and the shift value shift may be equal to two. When the first predicting mode is one of the Planar mode and the DC mode and only one of the first and second neighboring modes is included in the intra regular modes, the weighting factor W₂ of the second predicting mode may be equal to two and the shift value shift may be equal to two. When the first predicting mode is one of the Planar mode and the DC mode and both of the first and second neighboring modes are generated using the second specific prediction mode, the weighting factor W₂ of the second predicting mode may be equal to three and the shift value shift may be equal to two. Otherwise (e.g., when the DIMD mode candidate belongs to one of directional modes: horizontal mode or vertical mode), the final prediction is obtained by adaptively switching the prediction samples of the intra regular mode and the second specific prediction mode. It should be noted that the shift value shift and the weighting factor W₂ of the second predicting mode may be changed without departing from the scope of the present disclosure.

The decoder module 124 may derive the weighting factors of the predicting modes based on multiple comparisons between a current template region of the block unit and multiple reference template regions of multiple reference blocks generated using the IntraTMP predicting modes, when one of the first specific prediction mode and the second specific prediction mode is the IntraTMP prediction mode. In addition, the decoder module 124 may derive the weighting factors of the predicting modes based on multiple comparisons between the current template region of the block unit and multiple reference template regions of multiple reference blocks generated using the DIMD predicting modes, when one of the first specific prediction mode and the second specific prediction mode is the DIMD prediction mode. The current template region of the block unit may neighbor to the block unit. The reference blocks may include multiple reconstructed samples included in the current frame and be respectively indicated by one of the IntraTMP predicting modes. In addition, the reference blocks may include multiple reconstructed samples included in the current frame and be respectively generated by one of the DIMD predicting modes. The decoder module 124 may determine the reference template regions for each of the reference blocks based on a template size and a template position of the current template region.

The decoder module 124 may derive the weighting factors of the IntraTMP predicting modes based on the comparisons by using an LDL decomposition or a Gaussian elimination. The LDL decomposition and the Gaussian elimination may be used to solve multiple equations to determine the weighting factors of the IntraTMP predicting modes. In some implementations, the weighting factors of other predicting modes different from the IntraTMP predicting modes may be predefined to respectively be multiple fixed constants.

The decoder module 124 may derive the weighting factors of the predicting modes based on multiple template matching cost values between the current template region of the block unit and the reference template regions of the reference blocks, when one of the first specific prediction mode and the second specific prediction mode is the IntraTMP prediction mode or the DIMD prediction mode. Thus, the decoder module 124 may determine a portion of the predicting modes selected from the IntraTMP mode candidates and/or the DIMD mode candidates (i.e., the IntraTMP predicting modes and/or the DIMD predicting modes) generated using the IntraTMP prediction mode and/or the DIMD prediction mode. In addition, the decoder module 124 may determine a number L of the portion of the predicting modes and determine the weighting factors for the portion of the predicting modes based on the number L. In some implementations, the number L is an integer equal to or greater than zero. The decoder module 124 may determine the template matching cost values each generated from a corresponding one of the IntraTMP predicting modes and the DIMD predicting modes. Thus, a portion of the weighting factors for the IntraTMP predicting modes and the DIMD predicting modes may be determined based on the template matching cost values. The template matching cost values may be calculated based on a Sum of Absolute Difference (SAD) calculation, a Sum of Absolute Transformed Difference (SATD), or a Rate Distortion (RD) calculation. When the template matching cost values are generated, the weighting factors of the IntraTMP predicting modes and/or the DIMD predicting modes may be derived as follows:

$$sum = {\sum }_{t = 1}^{L} {cost}_{t}$$

$${W}_{t} = \frac{sum - {cost}_{t}}{( L - 1 ) \times sum} ,$$

$$t ∈ 1 , … , L$$

where costₜ is a template matching cost value of an x-th IntraTMP predicting mode or a template matching cost value of a z-th DIMD predicting mode, Wₜ is a weighting factor of the x-th IntraTMP predicting mode or a weighting factor of the z-th DIMD predicting mode, and the number L is the number of the IntraTMP predicting modes or the DIMD predicting modes. In some implementations, when one of the first and second specific prediction modes is the IntraTMP prediction mode and the other one is the DIMD prediction mode, the sum of the template matching cost values may be a sum of the template matching cost values of the IntraTMP predicting modes and the template matching cost values of the DIMD predicting modes. Thus, when deriving the weighting factors of the IntraTMP predicting modes and the DIMD predicting modes, the number L may be the number of the intraTMP predicting modes and the DIMD predicting modes. In some implementations, the weighting factors of other predicting modes different from the IntraTMP predicting modes and the DIMD predicting modes may be predefined to respectively be multiple fixed constants.

The decoder module 124 may derive the weighting factors of the DIMD predicting modes based on amplitudes of the HoG, when the first specific prediction mode is the DIMD prediction mode. Each of the weighting factors of the DIMD predicting modes may be proportional to each of the amplitudes of the HoG.

Each of the weighting factors of the predicting modes may be predefined to respectively be one of multiple fixed constants. The fixed constants may be different from or equal to each other. In some implementations, the decoder module 124 may determine the number N of the predicting modes, and determine the weighting factors of the predicting modes based on the number N. The number N may be an integer equal to or greater than two. In some implementations, each of the weighting factors may be equal to a fixed constant generated by dividing a fixed value by the number for the weighting factors (i.e., the number of the predicting modes). For example, the weighting factors may be equal to 0.25 when the fixed value is equal to one and the number of the weighting factors is equal to four.

In some implementations, when the prediction block of the block unit is derived based on a function, the function may further include a constant value corresponding to a weighting factor of the constant value. The functions may be shown as follows:

$$P = ( {\sum }_{i = 1}^{T} {W}_{i} \times {P}_{i} ) + {W}_{C} \times C$$

$$P = ( {W}_{1} \times {P}_{1} + {W}_{2} \times {P}_{2} + 2 ) ≫ 2 + {W}_{C} \times C$$

$$P = ( {W}_{1} \times {P}_{1} + ( ( 1 ≪ shift ) - {W}_{1} ) \times {P}_{2} + ( 1 ≪ ( shift - 1 ) ) ) ≫ shift + {W}_{C} \times C$$

where the number C is the constant value, and the number W_{C} is the weighting factor of the constant value. In some implementations, the constant may be determined based on a bitdepth of multiple samples in the block unit. For example, the constant value C of the block unit may be equal to 1<<(bitdepth−1). When the bitdepth is equal to 10, the constant value C may be equal to 512.

The decoder module 124 may reconstruct the block unit based on the prediction block. The decoder module 124 may determine multiple residual components from the bitstream for the block unit and add the residual components into the prediction block to reconstruct the block unit. The decoder module 124 may reconstruct all of the other block units in the image frame for reconstructing the image frame and the video. The method/process 500 may then end.

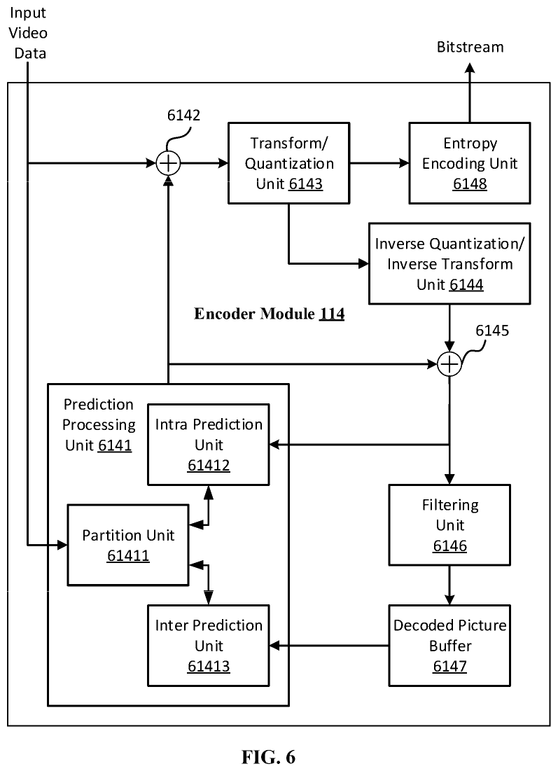

FIG. 6 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 6141), at least a first summer (e.g., a first summer 6142) and a second summer (e.g., a second summer 6145), a transform/quantization processor (e.g., a transform/quantization unit 6143), an inverse quantization/inverse transform processor (e.g., an inverse quantization/inverse transform unit 6144), a filter (e.g., a filtering unit 6146), a decoded picture buffer (e.g., a decoded picture buffer 6147), and an entropy encoder (e.g., an entropy encoding unit 6148). The prediction processing unit 6141 of the encoder module 114 may further include a partition processor (e.g., a partition unit 61411), an intra prediction processor (e.g., an intra prediction unit 61412), and an inter prediction processor (e.g., an inter prediction unit 61413). The encoder module 114 may receive the source video and encode the source video to output a bitstream.

The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 6141 may receive a current image block of a specific one of the image frames. The current image block may be the luminance block or one of the chrominance blocks in the specific image frame.

The partition unit 61411 may divide the current image block into multiple block units. The intra prediction unit 61412 may perform intra-predictive coding of a current block unit relative to one or more neighboring blocks in the same frame as the current block unit in order to provide spatial prediction. The inter prediction unit 61413 may perform inter-predictive coding of the current block unit relative to one or more blocks in one or more reference image blocks to provide temporal prediction.

The prediction processing unit 6141 may select one of the coding results generated by the intra prediction unit 61412 and the inter prediction unit 61413 based on a mode selection method, such as a cost function. The mode selection method may be a rate-distortion optimization (RDO) process.

The prediction processing unit 6141 may determine the selected coding result and provide a predicted block corresponding to the selected coding result to the first summer 6142 for generating a residual block and to the second summer 6145 for reconstructing the encoded block unit. The prediction processing unit 6141 may further provide syntax elements, such as motion vectors, intra-mode indicators, partition information, and/or other syntax information, to the entropy encoding unit 6148.

The intra prediction unit 61412 may intra-predict the current block unit. The intra prediction unit 61412 may determine an intra prediction mode directed toward a reconstructed sample neighboring the current block unit in order to encode the current block unit.

The intra prediction unit 61412 may encode the current block unit using various intra prediction modes. The intra prediction unit 61412 of the prediction processing unit 6141 may select an appropriate intra prediction mode from the selected modes. The intra prediction unit 61412 may encode the current block unit using a cross-component prediction mode to predict one of the two chroma components of the current block unit based on the luma components of the current block unit. The intra prediction unit 61412 may predict a first one of the two chroma components of the current block unit based on the second of the two chroma components of the current block unit.

The inter prediction unit 61413 may inter-predict the current block unit as an alternative to the intra prediction performed by the intra prediction unit 61412. The inter prediction unit 61413 may perform motion estimation to estimate motion of the current block unit for generating a motion vector.

The motion vector may indicate a displacement of the current block unit within the current image block relative to a reference block unit within a reference image block. The inter prediction unit 61413 may receive at least one reference image block stored in the decoded picture buffer 6147 and estimate the motion based on the received reference image blocks to generate the motion vector.

The first summer 6142 may generate the residual block by subtracting the prediction block determined by the prediction processing unit 6141 from the original current block unit. The first summer 6142 may represent the component or components that perform this subtraction.

The transform/quantization unit 6143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 6143 may perform a scan of the matrix including the quantized transform coefficients. Alternatively, the entropy encoding unit 6148 may perform the scan.

The entropy encoding unit 6148 may receive multiple syntax elements from the prediction processing unit 6141 and the transform/quantization unit 6143, including a quantization parameter, transform data, motion vectors, intra modes, partition information, and/or other syntax information. The entropy encoding unit 6148 may encode the syntax elements into the bitstream.

The entropy encoding unit 6148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 6144 may apply inverse quantization and inverse transformation to reconstruct the residual block in the pixel domain for later use as a reference block. The second summer 6145 may add the reconstructed residual block to the prediction block provided by the prediction processing unit 6141 in order to produce a reconstructed block for storage in the decoded picture buffer 6147.

The filtering unit 6146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 6145.

The decoded picture buffer 6147 may be a reference picture memory that stores the reference block to be used by the encoder module 614 to encode video, such as in intra-coding or inter-coding modes. The decoded picture buffer 6147 may include a variety of memory devices, such as DRAM (e.g., including SDRAM), MRAM, RRAM, or other types of memory devices. The decoded picture buffer 6147 may be on-chip with other components of the encoder module 114 or off-chip relative to those components.

The method/process 300 for decoding and/or encoding video data may be performed by the first electronic device 110. With reference to FIGS. 1, 3, and 6, at block 310, the method/process 300 may start by the encoder module 114 receiving the video data. The video data received by the encoder module 114 may be a video. At block 320, the encoder module 114 determines a chroma current block from a current frame included in the video data. The encoder module 114 may divide the current frame to generate multiple CTUs, and further divide one of the CTUs to determine the block unit including the chroma current block and a luma current block according to the partition indications based on any video coding standard.

At block 330, the encoder module 114 determines a split line of the block unit based on a partition angle and a partition offset determined from the video data. The encoder module 114 may determine multiple angle candidates and multiple offset candidates from the video data. In some implementations, the encoder module 114 may determine multiple split lines of the block unit based on the angle candidates and the offset candidates. When the number of the angle candidates is equal to the number U and the number of the offset candidates is equal to the number V, the number of the splits line may be greater than or equal to the minimum of the numbers U and V and less than or equal to a first product value generated by multiplying the number U by the number V.

At block 340, the encoder module 114 divides the block unit based on the determined split line to generate multiple geometric partitions. In some implementations, the encoder module 114 may divide the block unit based on the split lines and multiple candidate widths to generate multiple sets of the geometric partitions. The number of the split lines may be equal to the number W and the number of the candidate widths may be equal to the number X. The number of the sets of the geometric partitions may be greater than or equal to the minimum of the numbers W and X. In some implementations, the number of the sets of the geometric partitions may be less than or equal to a second product value generated by multiplying the number W by the number X when a first blending width BW1 is equal to a second blending width BW2. In some other implementations, the number of the sets of the geometric partitions may be less than or equal to a third product value generated by multiplying the number W by X×(X−1) when the first blending width BW1 is different from the second blending width BW2. In yet other implementations, the number of the sets of the geometric partitions may be less than or equal to a third product value generated by multiplying the number W by 2×X when the first blending width BW1 is allowable to be equal to or different from the second blending width BW2. The division method of each set of the geometric partitions performed by the encoder module 114 may be identical to the division method of the geometric partitions performed by the decoder module 124.

At block 350, the encoder module 114 determines, for the block unit, an intra candidate list including more than one of multiple intra template matching prediction (IntraTMP) mode candidates and multiple intra block copy (IBC) mode candidates. The intra candidate list generated by the encoder module 114 may be identical to the intra candidate list generated by the decoder module 124.

At block 360, the encoder module 114 selects multiple predicting modes from the determined intra candidate list. The encoder module 114 may select a first predicting mode from the IntraTMP mode candidates and a second predicting mode from the IBC mode candidates and other IntraTMP mode candidates different from the first predicting mode to generate one of multiple predicting sets. When the number of the IntraTMP mode candidates is equal to the number A and the number of the IBC mode candidates is equal to the number B, the number of the predicting sets may be less than or equal to

$${C}_{2}^{A} + A \times B .$$

In some implementations, when the first predicting mode is predefined as a specific one of the IntraTMP mode candidates having the lowest one of multiple template matching cost values of the IntraTMP mode candidates, the encoder module 114 may further select a second predicting mode from the IBC mode candidates and other IntraTMP mode candidates different from the first predicting mode to generate one of the predicting sets. Thus, the number of the predicting sets may be less than or equal to A+B−1.

In some other implementations, the first and second predicting modes may be predefined as two specific ones of the IntraTMP mode candidates having the lowest two of multiple template matching cost values of the IntraTMP mode candidates. Thus, the encoder module 114 may determine only one predicting set including the two specific IntraTMP mode candidates.

At block 370, the encoder module 114 reconstructs the geometric partitions of the block unit based on the selected multiple predicting modes. The encoder module 114 may predict the block unit based on each of the at least one predicting set to generate a corresponding one of at least one first prediction block of the block unit. The encoder module 114 may further predict the block unit based on other prediction modes to generate multiple second prediction blocks. The encoder module 114 may select one of the at least one first prediction block and the second prediction blocks based on a mode selection method, such as a cost function. The mode selection method may be a rate-distortion optimization (RDO) process. The encoder module 114 may provide the selected prediction block to the first summer 6142 for generating a residual block and to the second summer 6145 for reconstructing the encoded block unit. The encoder module 114 may further provide syntax elements, such as an angle index, an offset index, a geometric partition index, at least one width index, zero or more mode candidate index, and/or other syntax information, to the entropy encoding unit 6148.

The encoder module 114 may reconstruct the block unit based on the residual block. The reconstruction of the block unit by the encoder module 114 may be identical to the reconstruction of the block unit by the decoder module 124. The method/process 300 for the encoder module 114 may then end.

The method/process 500 for decoding and/or encoding video data may be performed by the first electronic device 110. With reference to FIGS. 1, 5, and 6, at block 510, the method/process 500 may start by the encoder module 114 receiving the video data. The video data received by the encoder module 114 may be a video. At block 520, the encoder module 114 determines a chroma current block from a current frame included in the video data. The encoder module 114 may divide the current frame to generate multiple CTUs, and further divide one of the CTUs to determine the block unit including the chroma current block and a luma current block according to the partition indications based on any video coding standard.

At block 530, the encoder module 114 determines an intra candidate list for the block unit. The intra candidate list may include more than one of multiple intra template matching prediction (IntraTMP) mode candidates, multiple intra block copy (IBC) mode candidates, or multiple decoder-side intra mode derivation (DIMD) mode candidates. The IntraTMP mode candidates may be generated using an IntraTMP prediction mode. The IBC mode candidates may be generated using an IBC prediction mode. The DIMD mode candidates may be generated using a DIMD prediction mode. The intra candidate list may be generated based on two different ones of the IntraTMP prediction mode, the IBC prediction mode, and the DIMD prediction mode. The intra candidate list generated by the encoder module 114 may be identical to the intra candidate list generated by the decoder module 124.

At block 540, the encoder module 114 selects multiple predicting modes from the determined intra candidate list. The predicting modes may include at least one first predicting mode included in a first predicting group and at least one second predicting mode included in a second predicting group. The at least one first predicting mode and the at least one second predicting mode may be generated using two different ones of the IntraTMP prediction mode, the IBC prediction mode, and the DIMD prediction mode. In some implementations, the at least one first predicting mode may be generated using a first specific prediction mode, and the at least one second predicting mode may be generated using a second specific prediction mode. In addition, the first specific prediction mode may be one of the IntraTMP prediction mode, the IBC prediction mode, and the DIMD prediction mode, and the second specific prediction mode may be another one of the IntraTMP prediction mode, the IBC prediction mode, and the DIMD prediction mode.

In some implementations, when the number of the at least one first predicting mode and the number of the at least one second predicting mode are predefined, the encoder module 114 may generate multiple sets of the predicting modes based on the number of the at least one first predicting mode and the number of the at least one second predicting mode. In addition, when the number of the sets of the predicting modes is restricted to be less than a threshold, the generation of the sets of the predicting modes may be further based on the threshold. In some other implementations, when a specific one of the number of the at least one first predicting mode and the number of the at least one second predicting mode is predefined, the encoder module 114 may generate the sets of the predicting modes based on the specific number. In addition, the generation of the sets of the predicting modes may be further based on the threshold. In yet other implementations, when the number of the at least one first predicting mode and the number of the at least one second predicting mode are not predefined, the encoder module 114 may generate the sets of the predicting modes based on the threshold.

At block 550, the encoder module 114 reconstructs the block unit based on the selected multiple predicting modes. The encoder module 114 may predict the block unit based on each set of the predicting modes to generate a corresponding one of multiple first prediction blocks of the block unit.

For each set of the predicting modes, the encoder module 114 may predict the block unit using each of the predicting modes to respectively generate one of multiple predicted blocks. For example, in a specific one of the sets of the predicting modes, each of the predicted blocks may be generated based on a corresponding one of the predicting modes in the specific set. In other words, in the specific set, each of the predicted blocks may correspond to the predicting modes one-to-one. Furthermore, for each set of the predicting modes, the decoder module 124 may determine multiple weighting factors for the predicted blocks. For example, in the specific set, each of the predicted blocks may also correspond to the weighting factors one-to-one. The derivation of the weighting factors for each set of the predicting modes by the encoder module 114 may be identical to one of the derivations of the weighting factors by the decoder module 124.

For each set of the predicting modes, the encoder module 114 may weightedly combine the predicted blocks based on the weighting factors to generate a corresponding one of the first prediction blocks of the block unit. The encoder module 114 may further predict the block unit based on other prediction modes to generate multiple second prediction blocks. The encoder module 114 may select one of the first prediction blocks and the second prediction blocks based on a mode selection method, such as a cost function. The mode selection method may be a rate-distortion optimization (RDO) process. The encoder module 114 may provide the selected prediction block to the first summer 6142 for generating a residual block and to the second summer 6145 for reconstructing the encoded block unit. The encoder module 114 may further provide syntax elements, such as an angle index, an offset index, a geometric partition index, at least one width index, zero or more mode candidate index, and/or other syntax information, to the entropy encoding unit 6148.

The encoder module 114 may reconstruct the block unit based on the residual block. The reconstruction of the block unit by the encoder module 114 may be identical to the reconstruction of the block unit by the decoder module 124. The method/process 500 for the encoder module 114 may then end.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit from a current frame included in the video data;
determine a split line of the block unit based on a partition angle and a partition offset determined from the video data;
divide the block unit based on the split line to generate a plurality of geometric partitions;
determine, for the block unit, an intra candidate list that includes at least one of a plurality of intra template matching prediction (IntraTMP) mode candidates, or at least one of a plurality of intra block copy (IBC) mode candidates or a combination of at least one of the plurality of IntraTMP mode candidates and at least one of the plurality of IBC mode candidates;
select a plurality of predicting modes from the intra candidate list, wherein a first one of the plurality of predicting modes is a first one of the plurality of IntraTMP mode candidates; and
reconstruct the plurality of geometric partitions of the block unit based on the plurality of predicting modes, wherein each of the plurality of geometric partitions in the block unit is reconstructed using at least one of the plurality of predicting modes.

2. The non-transitory machine-readable medium of claim 1, wherein:
a first one of the plurality of geometric partitions is predicted using the first one of the plurality of predicting modes,
a second one of the plurality of geometric partitions is predicted using a second one of the plurality of predicting modes, and
a third one of the plurality of geometric partitions is predicted using the first one and the second one of the plurality of predicting modes when a number of the plurality of geometric partitions is equal to three.

3. The non-transitory machine-readable medium of claim 2, wherein when the second one of the plurality of predicting modes is a second one of the plurality of IntraTMP mode candidates, the third one of the plurality of geometric partitions is predicted using the first one and the second one of the plurality of IntraTMP mode candidates.

4. The non-transitory machine-readable medium of claim 2, wherein when the second one of the plurality of predicting modes is one of the plurality of IBC mode candidates, the third one of the plurality of geometric partitions is predicted using the first one of the plurality of IntraTMP mode candidates and the one of the plurality of IBC mode candidates.

5. (canceled)

6. The non-transitory machine-readable medium of claim 2, wherein:
a partition size of the third one of the plurality of geometric partitions is determined based on at least one blending width of the block unit, and
the third one of the plurality of geometric partitions is predicted further based on the at least one blending width.

7. The non-transitory machine-readable medium of claim 6, wherein the third one of the plurality of geometric partitions is predicted by:
generating a first predicted sub-partition for the third one of the plurality of geometric partitions based on the first one of the plurality of predicting modes;
generating a second predicted sub-partition for the third one of the plurality of geometric partitions based on the second one of the plurality of predicting modes; and
weightedly combining the first predicted sub-partition and the second predicted sub-partition based on the at least one blending width.

8. (canceled)

9. The non-transitory machine-readable medium of claim 1, wherein:
a second one of the plurality of predicting modes is selected from the plurality of IntraTMP mode candidates and the plurality of IBC mode candidates, and
the second one of the plurality of predicting modes is different from the first one of the plurality of predicting modes.

10. An electronic device for decoding video data, the electronic device comprising:
at least processor; and
at least one non-transitory computer-readable medium coupled to the at least one processor and storing one or more computer-executable instructions that, when executed by the at least processor, cause the electronic device to:
receive the video data;
determine a block unit from a current frame included in the video data;
determine a split line of the block unit based on a partition angle and a partition offset determined from the video data;
divide the block unit based on the split line to generate a plurality of geometric partitions;
determine, for the block unit, an intra candidate list that includes at least one of a plurality of intra template matching prediction (IntraTMP) mode candidates, or at least one of a plurality of intra block copy (IBC) mode candidates or a combination of at least one of the plurality of IntraTMP mode candidates and at least one of the plurality of IBC mode candidates;
select a plurality of predicting modes from the intra candidate list, wherein a first one of the plurality of predicting modes is a first one of the plurality of IntraTMP mode candidates; and
reconstruct the plurality of geometric partitions of the block unit based on the plurality of predicting modes, wherein each of the plurality of geometric partitions in the block unit is reconstructed using at least one of the plurality of predicting modes.

11-19. (canceled)

20. The electronic device of claim 10, wherein:
a first one of the plurality of geometric partitions is predicted using the first one of the plurality of predicting modes,
a second one of the plurality of geometric partitions is predicted using a second one of the plurality of predicting modes, and
a third one of the plurality of geometric partitions is predicted using the first one and the second one of the plurality of predicting modes when a number of the plurality of geometric partitions is equal to three.

21. The electronic device of claim 20, wherein:
a partition size of the third one of the plurality of geometric partitions is determined based on at least one blending width of the block unit, and
the third one of the plurality of geometric partitions is predicted further based on the at least one blending width.

22. The electronic device of claim 10, wherein:
a second one of the plurality of predicting modes is selected from the plurality of IntraTMP mode candidates and the plurality of IBC mode candidates, and
the second one of the plurality of predicting modes is different from the first one of the plurality of predicting modes.

23. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from a current frame included in the video data;
determine a split line of the block unit based on a partition angle and a partition offset determined from the video data;
divide the block unit based on the split line to generate a plurality of geometric partitions;
determine, for the block unit, an intra candidate list that includes at least one of a plurality of intra template matching prediction (IntraTMP) mode candidates, or at least one of a plurality of intra block copy (IBC) mode candidates or a combination of at least one of the plurality of IntraTMP mode candidates and at least one of the plurality of IBC mode candidates;
select a plurality of predicting modes from the intra candidate list, wherein a first one of the plurality of predicting modes is a first one of the plurality of IntraTMP mode candidates; and
reconstruct the plurality of geometric partitions of the block unit based on the plurality of predicting modes, wherein each of the plurality of geometric partitions in the block unit is reconstructed using at least one of the plurality of predicting modes.

24. The electronic device of claim 23, wherein:
a first one of the plurality of geometric partitions is predicted using the first one of the plurality of predicting modes,
a second one of the plurality of geometric partitions is predicted using a second one of the plurality of predicting modes, and
a third one of the plurality of geometric partitions is predicted using the first one and the second one of the plurality of predicting modes when a number of the plurality of geometric partitions is equal to three.

25. The electronic device of claim 24, wherein:
a partition size of the third one of the plurality of geometric partitions is determined based on at least one blending width of the block unit, and
the third one of the plurality of geometric partitions is predicted further based on the at least one blending width.

26. The electronic device of claim 23, wherein:
a second one of the plurality of predicting modes is selected from the plurality of IntraTMP mode candidates and the plurality of IBC mode candidates, and
the second one of the plurality of predicting modes is different from the first one of the plurality of predicting modes.
